(19) United States
(12) Patent Application Publication
(10) Pub. No.: US 2022/0023920 A1
(43) Pub. Date: Jan. 27, 2022

(54) AIR SHOWER CLEANING DEVICE WITH NON-DEFEATABLE FUNCTION

(71) Applicant: TRIPLE WIN TECHNOLOGY(SHENZHEN) CO.LTD., Shenzhen (CN)

(72) Inventor: WEI-ZE WONG, Shenzhen (CN)

(21) Appl. No.: 16/950,628

(22) Filed: Nov. 17, 2020

(51) Int. Cl. B08B 5/02; B08B 15/02

(52) U.S. Cl. CPC B08B 5/023; B08B 15/02

(57) ABSTRACT

An air shower device with a non-defeatable function of removing contaminants from objects within a receiving space includes a room, a first barrier, a second barrier, and two revolving doors. The room defines the receiving space. The first barrier is disposed in the receiving space. The second barrier is disposed in the receiving space. The first barrier and the second barrier are misaligned with each other. The first barrier and the second barrier divide the receiving space into a plurality of channels connected to each other. The channels are arranged in a zigzag manner. The two revolving doors are installed at two ends of the channels.

The subject matter herein generally relates to sterilizing techniques, and more particularly, to an air shower device.

### BACKGROUND

Air showers are installed at an entrance to a clean room for medical procedures, manufacturing semiconductors, precision electronics, and food. When objects (such as people or goods) enter the air shower, clean air is jetted out, which should remove dust particles attached to surface of the objects.

However, when the objects stay in the air shower only for a short time, the air shower may not completely remove the dust particles, and thus a sterile or cleaned atmosphere is lost. Therefore, there is a room for improvement.

### BRIEF DESCRIPTION OF THE DRAWINGS

FIG. 1 is a diagrammatic view of an embodiment of an air shower device.

FIG. 2 is a top view of the air shower device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the said features. In the description of embodiments of the invention, “multiple” means two or more, unless otherwise specifically defined.

The terms “center”, “length”, “width”, “thickness”, “top”, “bottom”, “front”, “back”, “left”, “right”, “vertical”, “horizontal”, “inside”, “outside”, and other indicating directions or positions are based on the directions or positions shown in the attached drawings. In order to facilitate the description of the embodiment and simplify the description of the invention, rather than indicating or implying that the device or element referred to must have a specific orientation, and must be constructed and operated in a specific manner, it cannot be understood as a limitation of the embodiments of the disclosure.

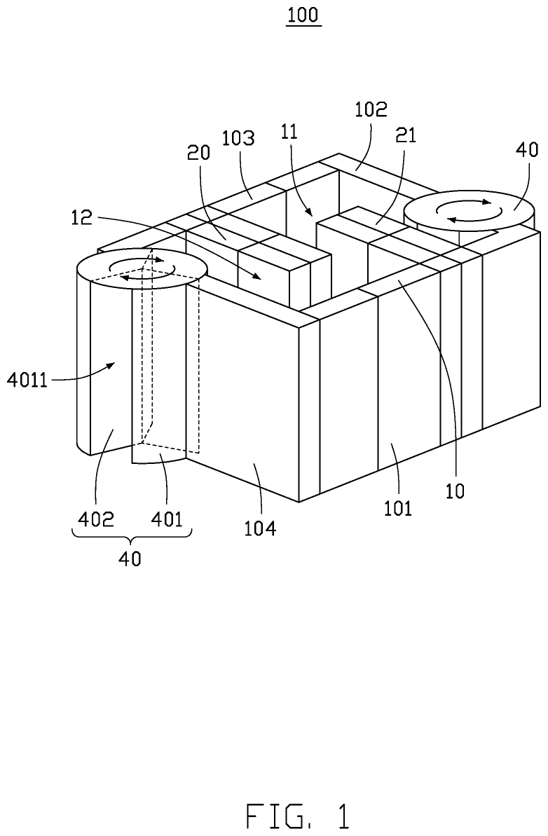

FIG. 1 illustrates an embodiment of an air shower device 100. The air shower device 100 includes a room 10, a first barrier 20, a second barrier 21, and two revolving doors 40.

In an embodiment, the room 10 includes a first sidewall 101, a second sidewall 102, a third sidewall 103, and a fourth sidewall 104. The first sidewall 101, the second sidewall 102, the third sidewall 103, and the fourth sidewall 104 are connected in that order. The first sidewall 101 is opposite to the third sidewall 103, and the second sidewall 102 is opposite to the fourth sidewall 104. In an embodiment, the first sidewall 101 is parallel to the third sidewall 103, and the second sidewall 102 is parallel to the fourth sidewall 104. The room 10 is substantially rectangular. The first sidewall 101, the second sidewall 102, the third sidewall 103, and the fourth sidewall 104 cooperatively define a receiving space 11.

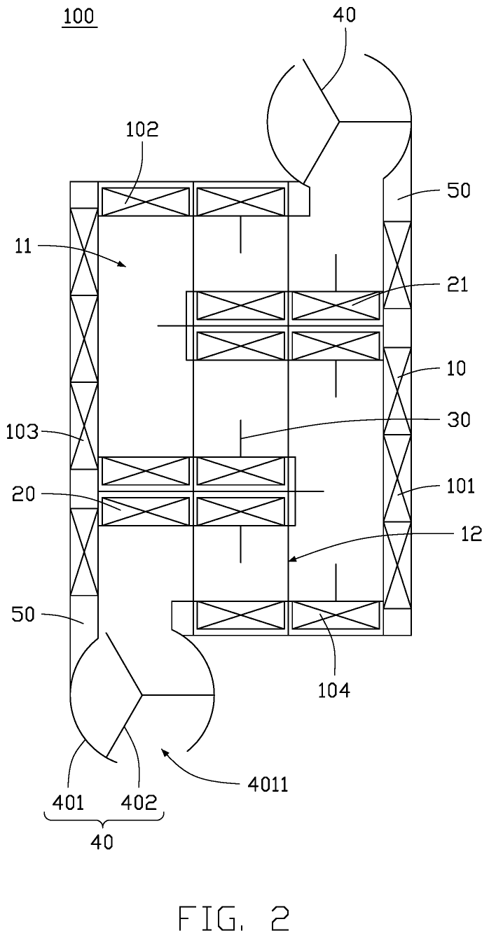

In an embodiment, the first barrier 20 and the second barrier 21 are disposed in the receiving space 11. The first barrier 20 is fixed to the third sidewall 103. The second barrier 21 is fixed to the first sidewall 101. The first barrier 20 and the second barrier 21 are not in line with each other. That is, the first barrier 20 and the second barrier 21 are located on different planes. Therefore, the first barrier 20 and the second barrier 21 divide the receiving space 11 into a plurality of channels 12 connected to each other. The channels 12 are arranged in a zigzag manner (such as a snakelike manner shown in FIG. 2).

In an embodiment, only one first barrier 20 and only one second barrier 21 are included in the receiving space 11. In other embodiments, the numbers of the first and second barriers 20 and 21 in the receiving space 11 may be more than one. Along a direction from the second sidewall 102 to the fourth sidewall 104, a plurality of the first barrier 20 and a plurality of the second barrier 21 are alternately arranged.

When objects pass through the receiving space 11, the objects need to pass through the channels 12, thereby forcing the objects to spend more time inside the receiving space 11. Thus, a better effect of air or other gas being blown out is obtained.

Referring to FIG. 2, each of the channels 12 includes at least one air jet 30. The air jet 30 may be a rotary air jet. In an embodiment, the air jet 30 may be disposed on the second sidewall 102, the fourth sidewall 104, both sides of the first barrier 20, or both sides of the second barrier 21. In an embodiment, the air jet 30 disposed on the second sidewall 102 is opposite to the first barrier 20. The air jet 30 disposed on the fourth axis 104 is opposite to the channel 12 between the second barrier 21 and the first sidewall 101. Gas can be blown out from the air jet 30, which cleans away the dust particles on the objects.

The two revolving doors 40 are installed at two ends of the channels 12. In an embodiment, one of the revolving doors 40 is fixed to one end of the second sidewall 102 adjacent to the first sidewall 101. The other revolving door 40 is fixed to one end of the fourth sidewall 104 adjacent to the third sidewall 103. The revolving door 40 includes an outer frame 401 fixed to the sidewall and a door body 402. The door body 402 is disposed in the outer frame 401 and can be rotated in the outer frame 401. The outer frame 401 includes two opposite openings 4011, and the objects can enter and exit the air shower device 100 only through the openings 4011.

In the embodiment, the two revolving doors 40 are each a three-leaf structure, the three leaves revolving on a single axis at 120 degrees to each other. The outer frame 401 of one of the revolving doors 40 is bonded between the first sidewall 101 and the second sidewall 102 by an adhesive 50. The outer frame 401 in the other of the revolving doors 40 is bonded between the third sidewall 103 and the fourth sidewall 104 by the adhesive 50. There is no gap between the door body 402 and the outer frame 401. Thereby, the two revolving doors 40 are always closed to prevent ingress of dust, wind, water and noise from outside. The revolving doors 40 can also prevent the cold air in the receiving space 11 from leaking out and so can maintain a certain temperature and humidity in the receiving space 11. The two revolving doors 40 are not interlocked. The door body 402 rotates in one single direction, which allows different objects to enter and exit from the two revolving doors 40 at the same time, thereby avoiding the objects getting stuck near the revolving doors 40. The door body 402 rotates according to a manual mode or an automatic mode. In the embodiment, the door body 402 rotates according to the manual mode, so that people can open and close the door body 402 by themselves, thereby increasing the safety of the revolving door 40. The revolving door 40 does not require a power supply and a door closer in the manual mode, that is, the revolving door 40 has simple structure.

In the present disclosure, the first barrier 20 and the second barrier 21 defines the receiving space 11 into the channels 12. When objects pass through the receiving space 11, the objects need to pass through the channels 12, thereby causing the objects to spend a certain amount of time in the receiving space 11. Thus, a better effect of the blown air is obtained.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. An air shower device, comprising:
a room, defining a receiving space;
a first barrier disposed in the receiving space;
a second barrier disposed in the receiving space; and
two revolving doors;
wherein the first barrier and the second barrier are misaligned with each other; the first barrier and the second barrier divide the receiving space into a plurality of channels connected to each other; the channels are arranged in a zigzag manner; the two revolving doors are installed at two ends of the plurality of channels.

2. The air shower device of claim 1, wherein each of the two revolving doors is three-page revolving door.

3. The air shower device of claim 2, wherein the revolving door comprises an outer frame fixed to the room and a door body, the door body is disposed in the outer frame and able to be rotated in the outer frame, and the outer frame comprises two opposite openings.

4. The air shower device of claim 3, wherein the door body rotates in one single direction.

5. The air shower device of claim 3, wherein the door body rotates according to a manual mode or an automatic mode.

6. The air shower device of claim 1, wherein the room comprises a first sidewall, a second sidewall, a third sidewall and a fourth sidewall, the first sidewall, the second sidewall, the third sidewall and the fourth sidewall are connected in that order, the first sidewall is opposite to the third sidewall, and the second sidewall is opposite to the fourth sidewall, the first sidewall, the second sidewall, the third sidewall and the fourth sidewall cooperatively define the receiving space.

7. The air shower device of claim 6, wherein the outer frame of one of the revolving doors is bonded between the first sidewall and the second sidewall by an adhesive, the outer frame in the other of the revolving doors is bonded between the third sidewall and the fourth sidewall by another adhesive.

8. The air shower device of claim 6, wherein the first barrier is fixed to the third sidewall, the second barrier is fixed to the first sidewall, and the first barrier and the second barrier are located on different planes.

9. The air shower device of claim 6, wherein one of the revolving doors is fixed to one end of the second sidewall adjacent to the first sidewall, the other revolving door is fixed to one end of the fourth sidewall adjacent to the third sidewall.

10. The air shower device of claim 6, wherein each of the channels comprises at least one air jet.

11. The air shower device of claim 9, wherein the air jet is disposed on the second sidewall, the fourth sidewall, both sides of the first barrier, or both sides of the second barrier.

12. The air shower device of claim 9, wherein the air jet disposed on the second sidewall is opposite to the first barrier, the air jet disposed on the fourth axis is opposite to the channel between the second barrier and the first sidewall.

13. The air shower device of claim 9, wherein the air jet is a rotary air jet.

14. The air shower device of claim 6 wherein the first sidewall is parallel to the third sidewall, and the second sidewall is parallel to the fourth sidewall.
